(19) United States
(12) Patent Application Publication
(10) Pub. No.: US 2020/0081102 A1
(43) Pub. Date: Mar. 12, 2020

(54) LADAR FOR MILITARY AND HARSH ENVIRONMENT USE

(71) Applicant: Robotic Research, LLC, Gaithersburg, MD (US)

(72) Inventors: Alberto Daniel Lacaze, Gaithersburg, MD (US); Karl Nicholas Murphy, Gaithersburg, MD (US); Steven Charles Rotundo, Gaithersburg, MD (US)

(21) Appl. No.: 16/127,001

(22) Filed: Sep. 10, 2018

(51) Int. Cl. G01S 7/481; G01S 7/48; G01S 17/89; G01S 17/58

(52) U.S. Cl. CPC G01S 7/4817; G01S 17/58; G01S 17/89; G01S 7/4802

(57) ABSTRACT

The light detection and ranging (LADAR) for military and harsh environment use disclosed herein presents a solution to the shortcomings inherent in modern systems. The system manipulates emitted beams to reduce or reallocate the energy required for detection, and may selectively deactivate beams to minimize that chances of detection by wasted or unrequired beam emissions. The system may also alter the divergence and amplitude of emitted beams so as to more accurately detect higher priority objects within the environment. The system may also manipulate the frequency and waveform of emitted beams to reduce the chances of a bystander detecting the emissions.

### CROSS REFERENCE TO RELATED PATENT APPLICATIONS

The present application makes no reference to any other related filed patent applications.

### STATEMENT REGARDING FEDERAL SPONSORSHIP

No part of this invention was a result of any federally sponsored research.

### TECHNICAL FIELD OF THE INVENTION

The present invention relates in general to active sensor systems, and, more specifically, to a light detection and ranging (LADAR) for military and harsh environment use.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Light detection and ranging (LADAR or LIDAR) is a surveying method that measures distance to a target by illuminating the target with pulsed laser light and measuring the reflected pulses with a sensor. Differences in laser return times and wavelengths can then be used to make digital three-dimensional representations of the target. Such systems are commonly used to make high-resolution maps, and are being used more commonly in the control and navigation of autonomous vehicles.

The pulsed laser light used in LADAR systems is received by light sensors and an accurate clock is used to measure the time of flight difference between the emitted burst and the received burst. Continuous wave LADARs emit a sine or other waveform that is reflected by the target object. As the reflected wane is received by the receiver the phase of the emitted waveform is compared to the phase of the received waveform. This phase shift is also used to determine the distance between the sensor and the target object. In structured light ranging sensors an emitted light that reflects on the target object is sensed by a camera, where the camera is located a known distance away from the emitter. In such systems distance may be computed by determining the angular offset between the emitted beam and the location of its detection. In all of the various systems a plurality of beams are emitted and measured so as to create a three-dimensional point cloud related to the environment.

A characteristic common to all of the above systems is the application of active sensors, which need to emit energy to probe the environment. Such emissions are problematic, especially in military applications, as they can be easily detected by third-party sensors. As a LADAR emitter illuminates a target object, for example, a bystander using an appropriately-tuned receiver can detect the source of these emissions. Most automotive LADARs emit light in the 905 nm or 1550 nm infrared band, which can be seen with most night optical devices even at significant distances. A bystander could also detect the emitted beams if they are projected into the ground as the surrounding objects reflect the light, though this method of detection is two to three orders of magnitude less efficient due to scattering of the light emission. Even state-of-the-art night optical devices would have to be fairly close to the emitter to detect the emission.

LADARs or structured light sensors generally do not benefit from beams that never provide a reflected return, such as beams that are reflected into the sky, and it is these non-reflected beams that are most easily detectable at long ranges. If nothing is known about the environment, emitting beams in all directions is the only way to determine where objects and the horizon may be. However, most systems have at least some prior knowledge of the environment garnered through previous scans or satellite imagery.

Therefore, there is a need in the art for a LADAR for military and harsh environment use that may selectively deactivate beams that are likely to be detected at long ranges due to non-reflective and other causes. It is to these ends that the present invention has been developed.

### BRIEF SUMMARY OF THE INVENTION

To minimize the limitations in the prior art, and to minimize other limitations that will be apparent upon reading and understanding the present specification, the present invention describes a light detection and ranging (LADAR) for military and harsh environment use.

It is an objective of the present invention to provide a light detection and ranging system that may comprise a beam emission selector.

It is another objective of the present invention to provide a light detection and ranging system that may comprise a beam divergence selector.

It is another objective of the present invention to provide a light detection and ranging system that may comprise a beam amplitude selector.

It is another objective of the present invention to provide a light detection and ranging system that may comprise a beam frequency selector.

It is another objective of the present invention to provide a light detection and ranging system that may comprise a beam waveform selector.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates an overview of a LADAR for military and harsh environment use with a beam emission selector, as contemplated by the present disclosure.

FIG. 2 illustrates an overview of a LADAR for military and harsh environment use with a beam divergence selector, as contemplated by the present disclosure.

FIG. 3 illustrates an overview of a LADAR for military and harsh environment use with a beam amplitude selector, as contemplated by the present disclosure.

FIG. 4 illustrates an overview of a LADAR for military and harsh environment use with a beam frequency selector, as contemplated by the present disclosure.

FIG. 5 illustrates an overview of a LADAR for military and harsh environment use with a beam waveform selector, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The present invention relates in general to active sensor systems, and, more specifically, to a light detection and ranging (LADAR) for military and harsh environment use that may selectively deactivate beams that are likely to be detected at long ranges due to non-reflective and other causes. As contemplated by the present disclosure, LADAR for military and harsh environment use may be installed on a vehicle, and may deactivate beams that point to the vehicle itself, point above the known horizon, or point to any undesired object or heading.

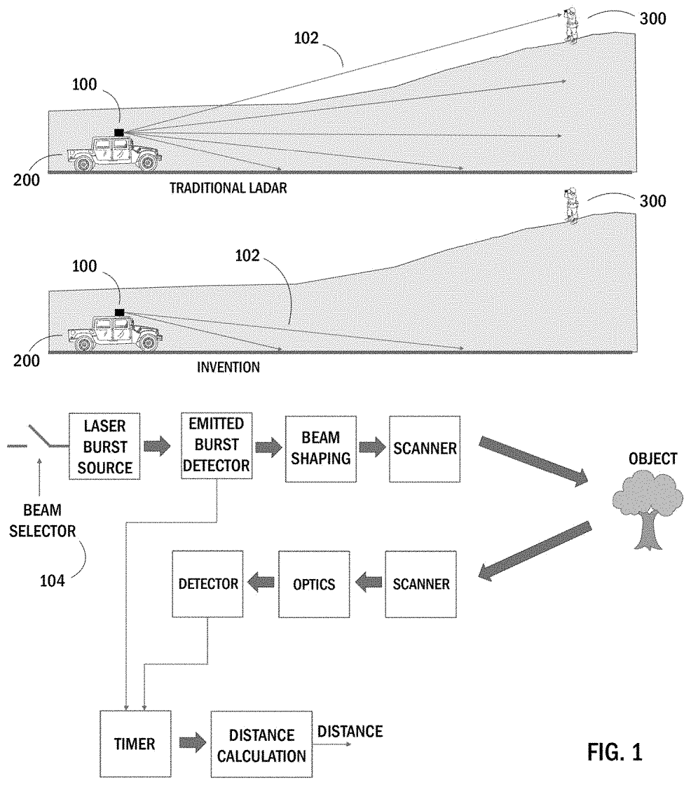

The illustration of FIG. 1 illustrates an overview of a LADAR for military and harsh environment use, specifically identifying a LADAR system 100, emitted beams 102, beam emission selector 104, vehicle 200, and bystander 300. Unless there is a need to repeatedly measure parts of the vehicle in which the sensor is mounted, the system can turn off beams that repeatedly hit the vehicle. Even though these are not direct beams, sent from the emitter to a bystander's receiver, they are usually high energy as the distances from the emitter and the reflected surface on the vehicle are small. Such high energy beams can still be detected at longer distances.

If prior knowledge of the terrain is known, there is no need to continue beaming above a certain elevation for most autonomous vehicle applications. For example, if the goal of the vehicle is to avoid people, there is no need to illuminate areas that are higher than a few feet above the support surface, as illuminating above that height does not provide new information. The knowledge of the elevation of the support surface can be obtained from prior scans.

The invention can also trigger beams directed to areas that have been determined to be support surfaces, and only grow the scan area by illuminating areas that are connected to the support areas and can become obstacles. For example, if the road has a jersey barrier that precludes the vehicle from traversing to the other side, under some circumstances, there may be no reason to scan the areas beyond the jersey barrier. As another example, a vertical column can be scanned from the bottom up. The first few range pixels immediately in front of the vehicle are used to determine if the area is traversable. The system will continue scanning up the column until it finds that the ranges are past a region of interest, they provide no returns, or an obstacle has been found. A more complex scanning pattern utilizes the search algorithms used for determining the possible trajectories of the vehicle and only scans areas that the planner determines it may have interest in traversing. For example, the planner may only be interested in driving forwards and only in the left lane, and the system can elect to only scan those areas and immediately surrounding areas where obstacles could encroach.

The invention can also use the kinematics and or dynamics of the vehicle to determine where to scan. For example, there is no need to illuminate areas next to the vehicle if the vehicle dynamics would not allow for the vehicle to react to any possible obstacle coming from that direction. The invention can also selectively abstain from scanning in a particular direction or directions where there is a suspected enemy observer. The sensor or host vehicle may also use its own internal gyroscope or gravity vector to stop beams above a certain elevation.

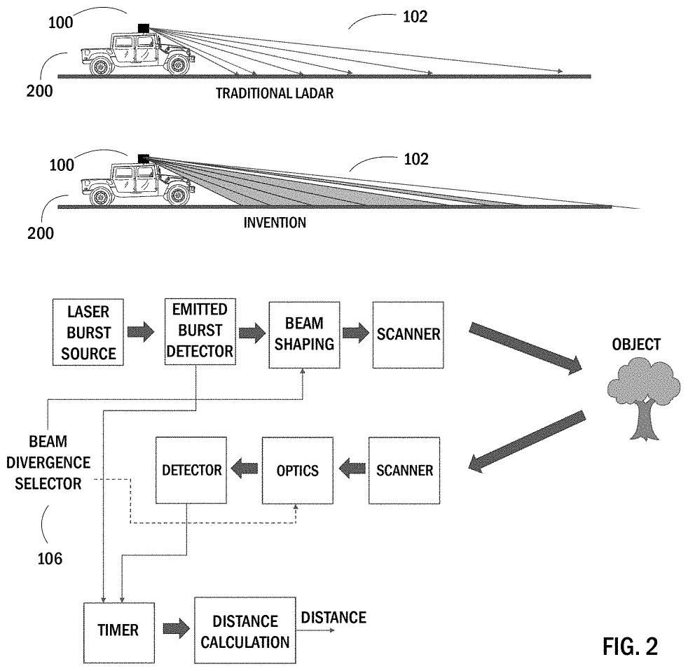

The illustration of FIG. 2 illustrates an overview of a LADAR for military and harsh environment use, specifically identifying a LADAR system 100, emitted beams 102, beam divergence selector 106, and vehicle 200. Current LADARs and structured light sensors have a preset beam divergence. Some manufacturers of LADARs for commercial vehicles are opting for larger beam divergences as these larger divergences create fewer or smaller blind spots, areas where the beams cannot reach. Blind spot reduction is important for detecting cables, chain link fences, sign poles, and other fine objects. A smaller beam divergence could potentially miss the narrow object as the vehicle moves towards the obstacle.

Unfortunately, these wider beam divergences have negative effects under certain circumstances. This becomes clear when detection of small obstacles at a distance is important. Most commercial uses of LADARs assume that the terrain is benign, and the road does not contain many small obstacles. This is not necessarily true for military or harsh environment applications, where detecting the traversibility of the environment is important. Large beam divergence also affects the ability to detect obstacles in vegetation and makes LADARs more susceptible to fog, dust, snow, and rain.

As contemplated by the present invention, the system allows the user to change the beam divergence by dynamically adjusting a set of optics. Mirrors, lenses, and other devices can also be used for performing this task. Micro-mirrors can also be used to create arrays of beams that cover larger areas while still maintaining small beam divergences, which is particularly beneficial if the LADAR receiver is capable of receiving multiple returns. The advantages of this approach is that the user can get the benefits of having narrow and wide beam divergence depending on the mission, the terrain, the weather, and the covert requirements.

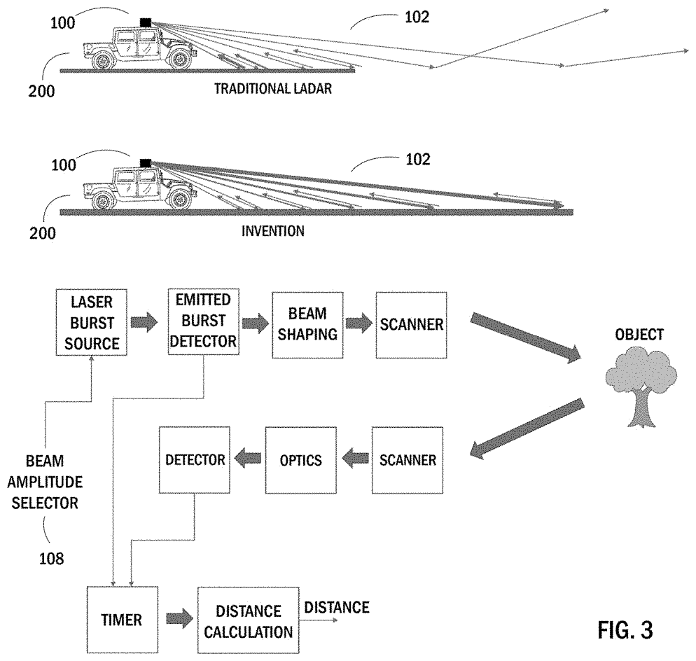

The illustration of FIG. 3 illustrates an overview of a LADAR for military and harsh environment use, specifically identifying a LADAR system 100, emitted beams 102, beam amplitude selector 108, and vehicle 200. Most LADARs and structured light systems used for ground applications are eye safe since making systems non-eye safe has significant implications that extend all the way to Geneva Convention rules. Eye safety is measured by several methods, and these methods vary depending on the frequency of the laser and the country doing the rating. In general, there are two main metrics that are used: average energy and maximum burst energy. For most LADARs the average energy is the determining factor for eye safety.

As contemplated by the present invention, the system is capable of changing the amount of energy emitted in each beam instantaneously. In other words, the user can vary the relative amount of energy for each beam as long as the average is maintained and maximum energy of each beam remains below the threshold of the particular eye safety category. The invention implements several methods for controlling the energy of each beam, especially by selectively turning certain beams on or off to present a significant covert advantage. The system allows for the rest of the beams in a scan to increase intensity and still maintain the average energy requirements, which is advantageous where energy can be emitted in areas that are more important from a traversibility standpoint.

Also, as the laser beams hit the ground, beams that are close to the vehicle usually provide good reflections as the angle of incidence with the ground is large. Where the beams hit the ground further away from the vehicle, the angles of incidence become progressively smaller, and the energy of the beam gets mostly reflected away from the sensor and less energy returns to the receiver. This is problematic when detecting the support surface because although LADARs can often see positive obstacles at great distances, their ability to detect the support surfaces is usually significantly less. The present system allows the user to use less energy on the road in areas that are closer to the vehicle where the angles of incidence are larger and use more energy at this artificial horizon where the LADAR cannot currently get a return because the angles of incidence are too shallow. As the autonomous system detects these horizons the system is used to redirect more energy to these areas.

The system may further apply more energy in areas where the vehicle is more likely to drive and support surfaces need to be detected, and less energy in areas in which the system is only interested in sensing vertical obstacles. The system can also apply more energy at the horizons and less energy at areas that have already been measured or scanned. The system can further apply more energy in areas that are determined by the RADAR or other sensors to have traversable occlusions, such as dust, fog, rain, or snow, and the vehicle may choose to use all of the energy permitted by the eye safe limits for peering through fog, rather than spending more energy on areas that are not as important. Finally, the system may decide to scan areas that are eye height with less intensity than other areas, such as where an observer may have a sensor for detecting LADAR.

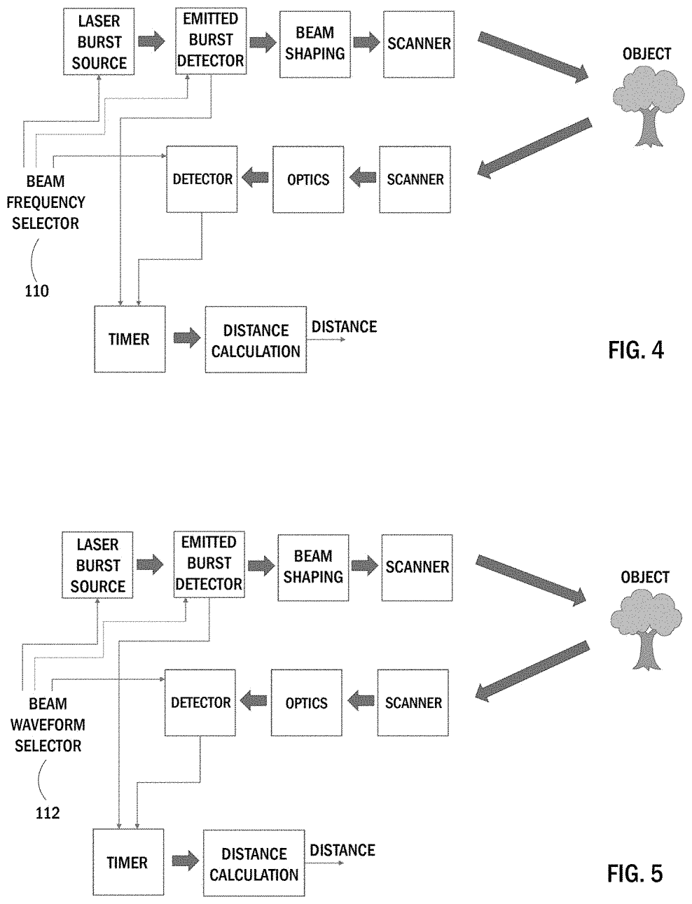

The illustration of FIG. 4 illustrates an overview of a LADAR for military and harsh environment use, specifically identifying beam frequency selector 110. Current state of the art LADAR sensors are single frequency or, in the case of continuous wave LADARs, may use multiple frequencies to disambiguate distances. A smart adversary can use a relatively low power emitter to blind a LADAR since the frequencies used by commercial LADARs are known and can be easily used by an adversary to create inexpensive devices that would stop a LADAR from working or confusing a structured light sensor.

As contemplated by the present invention, the system has the capability of dynamically changing frequencies to stop an adversary from easily creating a countermeasure against the sensor. In particular, tunable notch filters are used to filter overwhelming external sources that might disrupt the system, and the combination of tunable laser and modern notch filters allows the LADAR to switch frequencies. The advantages of such switching are multifold: covertness, resilience to jamming, and improved classification. Different materials reflect light differently at different frequencies. For example, some surfaces look very different when illuminated with different infrared bands, and therefore, the system can be used to classify wet pavement from dry pavement as well as many other relevant surface attributes.

In the present system, the LADAR can hop frequencies at random and is capable of switching frequencies on a beam per beam basis. Slower switches, as between individual scans, are also possible while still retaining all the advantages provided above. From a military standpoint, this capability can be used to selectively avoid areas of the spectrum that are more easily detectable by an adversary in some circumstances while employing those same frequencies in other circumstances in which they provide an advantage over the more covert frequencies. The system hops around the short wave infrared spectrum as the tunable components such as filters and broad receivers are available, and the same techniques can be used at long wave infrared, ultraviolet, and other frequencies.

The illustration of FIG. 5 illustrates an overview of a LADAR for military and harsh environment use, specifically identifying beam waveform selector 112. The main difference between burst LADARs and continuous wave LADARs is that continuous wave LADARs rely on the phase detection of a reflected waveform for range and velocity measurement. Because the time of flight at typical detection distances, 100 m-200 m, is very small, a LADAR must be able to very accurately detect the incoming wave and trigger the clock to stop. In the case of the burst, simple analog thresholds are used to define the time of flight. In the case of the continuous wave, phase lock loops and derivative circuits are used. However, the waveform is very resilient to noise, and, therefore, both systems will get false alarms even at relatively high signal to noise ratios (SNR). Gold codes and hamming sequences have been used in the past to achieve detection at significantly lower SNR. One excellent example is that of GPS signals that can usually be detected at SNR which could not be detected with burst transmissions. Unfortunately, the short time of flight does not allow for very complex waveforms, as they cannot be longer than a few nanoseconds without affecting the minimum range of the LADAR. More modernly commercially available timer integrated circuits that can measure the returning waveform at several instances have become available. The presented invention can use these timing integrated circuits currently used for multi-return LADARs as a method of imaging the returning wave. Different emitted waveforms that use longer encoded messages can be used to significantly increase the noise rejection during the detection of the reflected waveform. The advantage of this approach is multifold: longer detection distances, more beams while still being eye safe, and more covert beams.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims. Note with respect to the materials of construction, it is not desired nor intended to thereby unnecessarily limit the present invention by reason of such disclosure.

I claim:

1. A light detection and ranging system, comprising:
a plurality of LADAR emitters;
a plurality of LADAR sensors;
a control subsystem; and
an emission control device;
wherein said plurality of LADAR emitters output a plurality of light beams;
wherein said plurality of LADAR sensors input said plurality of light beams;
wherein said control subsystem directs the operation of the system;
wherein said emission control device modifies the output of said plurality of light beams; and
wherein said plurality of light beams further comprise a direction, a divergence, an intensity, a frequency, and a wavelength.

2. The invention of claim 1,
wherein said emission control device is a beam emission selector; and
wherein said beam emission selector modifies said direction of said plurality of light beams.

3. The invention of claim 2,
wherein said beam emission selector selectively prevents the emission of said plurality of light beams based on a plurality of environmental factors; and
wherein said plurality of environmental factors further comprise a vehicle position, a horizon position, a heading, an altitude, a vehicle motion, a road type, a surface type, and a weather type.

4. The invention of claim 1,
wherein said emission control device is a beam divergence selector; and
wherein said beam divergence selector modifies said divergence of said plurality of light beams based on said plurality of environmental factors.

5. The invention of claim 1,
wherein said emission control device is a beam amplitude selector; and
wherein said beam amplitude selector modifies said intensity of said plurality of light beams based on said plurality of environmental factors.

6. The invention of claim 5,
wherein said intensity of said plurality of light beams further comprises an average intensity; and
wherein said average intensity is maintained below an eye safety maximum intensity.

7. The invention of claim 1,
wherein said emission control device is a beam frequency selector; and
wherein said beam frequency selector modifies said frequency of said plurality of light beams based on said plurality of environmental factors.

8. The invention of claim 7,
wherein said frequency is changed randomly.

9. The invention of claim 1,
wherein said emission control device is a beam waveform selector; and
wherein said beam waveform selector modifies said wavelength of said plurality of light beams based on said plurality of environmental factors.

10. A structured light sensor system, comprising:
a plurality of laser emitters;
a plurality of laser sensors;
a control subsystem; and
an emission control device;
wherein said plurality of laser emitters output a plurality of light beams;
wherein said plurality of laser sensors input said plurality of light beams;
wherein said control subsystem directs the operation of the system;
wherein said emission control device modifies the output of said plurality of light beams; and
wherein said plurality of light beams further comprise a direction, a divergence, an intensity, a frequency, and a wavelength.

11. The invention of claim 10,
wherein said emission control device is a beam emission selector; and
wherein said beam emission selector modifies said direction of said plurality of light beams.

12. The invention of claim 11,
wherein said beam emission selector selectively prevents the emission of said plurality of light beams based on a plurality of environmental factors; and
wherein said plurality of environmental factors further comprise a vehicle position, a horizon position, a heading, an altitude, a vehicle motion, a road type, a surface type, and a weather type.

13. The invention of claim 10,
wherein said emission control device is a beam divergence selector; and
wherein said beam divergence selector modifies said divergence of said plurality of light beams based on said plurality of environmental factors.

14. The invention of claim 10,
wherein said emission control device is a beam amplitude selector; and
wherein said beam amplitude selector modifies said intensity of said plurality of light beams based on said plurality of environmental factors.

15. The invention of claim 14,
wherein said intensity of said plurality of light beams further comprises an average intensity; and
wherein said average intensity is maintained below an eye safety maximum intensity.

16. The invention of claim 10,
wherein said emission control device is a beam frequency selector; and
wherein said beam frequency selector modifies said frequency of said plurality of light beams based on said plurality of environmental factors.

17. The invention of claim 16,
wherein said frequency is changed randomly.

18. The invention of claim 10,
wherein said emission control device is a beam waveform selector; and
wherein said beam waveform selector modifies said wavelength of said plurality of light beams based on said plurality of environmental factors.
